(19) United States
(12) Patent Application Publication
(10) Pub. No.: US 2014/0152573 A1
(43) Pub. Date: Jun. 5, 2014

(54) INFORMATION PROCESSING APPARATUS, AND METHOD AND PROGRAM FOR CONTROLLING THE INFORMATION PROCESSING APPARATUS

(71) Applicant: Kabushiki Kaisha Toshiba, Tokyo (JP)

(72) Inventor: Koji Yamamoto, Tokyo (JP)

(73) Assignee: KABUSHIKI KAISHA TOSHIBA, Tokyo (JP)

(21) Appl. No.: 14/032,113

(22) Filed: Sep. 19, 2013

(30) Foreign Application Priority Data
Nov. 30, 2012 (JP) 2012-263068

(51) Int. Cl. G06F 3/02; G06F 3/041

(52) U.S. Cl. CPC G06F 3/02; G06F 3/041
USPC 345/168

(57) ABSTRACT

One embodiment provides an information processing apparatus including: a display device; a display device; a touch panel provided on a front surface of the display device, the touch panel including a first changeover unit; and mechanical keys arranged in a rear surface of the display device. The information processing apparatus includes a memory, a determination module and a controller. The memory stores plural designation information each corresponding to a designation of functions to the mechanical keys. The determination module determines whether the first changeover unit is selected through the touch panel or not. And, the controller determines one of the plural designation information in accordance with a determination result by the determination module, and changes the designation of functions to the mechanical keys based on the determined designation information.

### CROSS-REFERENCE TO RELATED APPLICATION(S)

This application claims priority/priorities from Japanese Patent Application No. 2012-263068 filed on Nov. 30, 2012, the entire contents of which are incorporated herein by reference.

### FIELD

Embodiments described herein relate generally to an information processing apparatus and a method and a program for controlling the information processing apparatus.

### BACKGROUND

While a mechanical keyboard (having mechanical keys) is traditionally used for character input or the like in an information processing apparatus such as a personal computer, recently, a virtual keyboard (having virtual keys displayed on a touch screen) to input characters or the like by touching operation become also popular, especially for a smartphone, a tablet terminal, etc. Further, some information processing apparatus has not only virtual keys displayed on its front surface (touch screen) but also mechanical keys arranged in its rear surface.

In such information processing apparatus, the mechanical keys will be arranged within a range to which user's fingers can reach so that the user can operate the information processing apparatus with the fingers while holding the apparatus. In view of above, depending on the apparatuses, the mechanical keys may not be arranged in a center portion of the rear surface to which the fingers can hardly reach.

The number of rear-surface mechanical keys arranged in the above-mentioned information processing apparatus is smaller than the number of mechanical keys arranged in a general keyboard. As a result, the above-mentioned information processing apparatus is inferior in input-operability using the mechanical keys due to its smaller number of keys as compared with a general keyboard.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a front view of an information processing apparatus according to a first embodiment.

FIG. 2 is a rear view of the information processing apparatus according to the first embodiment.

FIG. 3 is a view for explaining an example of operation of the information processing apparatus according to the first embodiment.

FIG. 4 illustrates an electrical configuration of the information processing apparatus according to the first embodiment.

FIG. 5 is a flow chart for explaining a process of changing a HW key mapping table.

FIG. 6 is a front view of an information processing apparatus according to a modification of the first embodiment.

FIG. 7 is an external view of an information processing apparatus according to a second embodiment.

FIGS. 8A and 8B are rear views of the information processing apparatus 1b folded in a direction of the arrow A.

FIG. 9 illustrates an electrical configuration of the information processing apparatus according to the second embodiment.

FIG. 10 is a flow chart for explaining a process of changing a HW key mapping table.

### DETAILED DESCRIPTION

One embodiment provides an information processing apparatus including: a display device; a display device; a touch panel provided on a front surface of the display device, the touch panel including a first changeover unit; and mechanical keys arranged in a rear surface of the display device. The information processing apparatus includes a memory, a determination module and a controller. The memory stores plural designation information each corresponding to a designation of functions to the mechanical keys. The determination module determines whether the first changeover unit is selected through the touch panel or not. And, the controller determines one of the plural designation information in accordance with a determination result by the determination module, and changes the designation of functions to the mechanical keys based on the determined designation information.

Embodiments will be described below in detail with reference to the drawings.

### First Embodiment

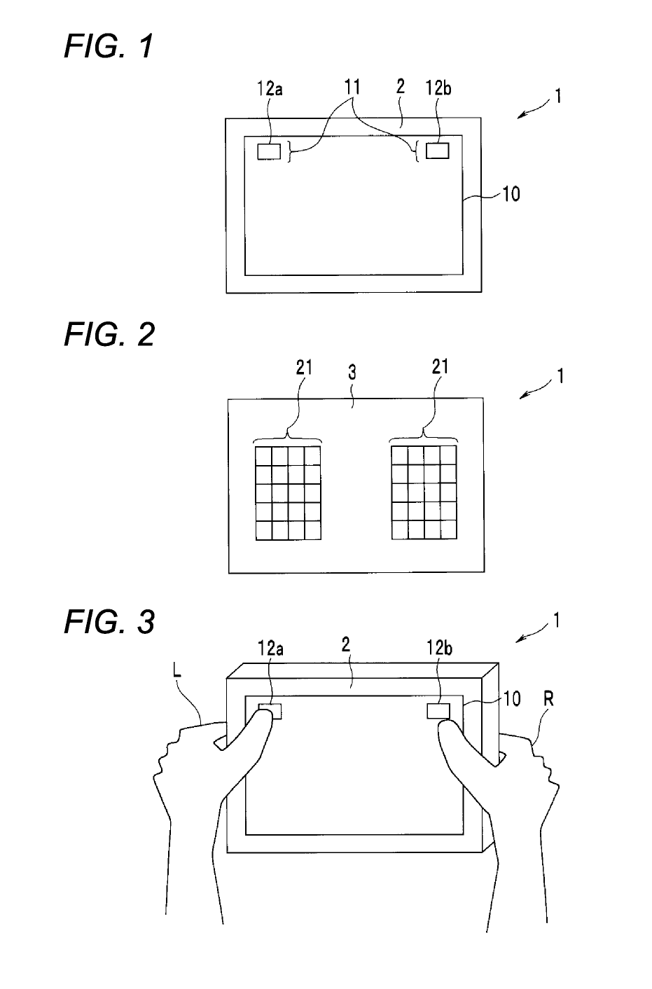

First, the configuration of an information processing apparatus according to a first embodiment will be described with reference to FIGS. 1 to 4.

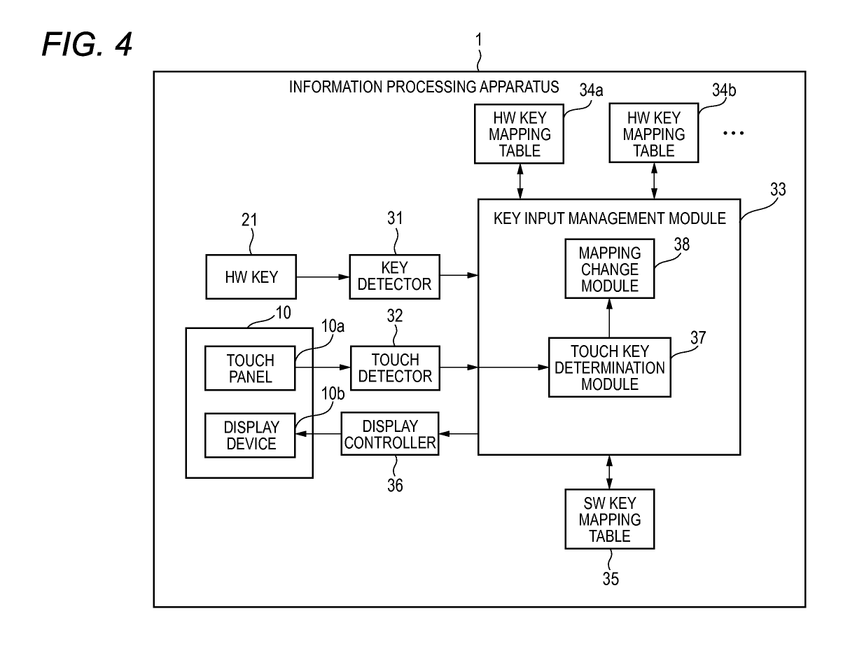

FIGS. 1 and 2 are a front view and a rear view of the information processing apparatus according to the first embodiment, respectively. FIG. 3 illustrates an example operation of the information processing apparatus. FIG. 4 illustrates an electrical configuration of the information processing apparatus.

As shown in FIG. 1, the information processing apparatus 1 is an information terminal such as a smartphone, a tablet terminal, etc. A touch screen 10 which serves as a touch panel 10a (see FIG. 4) and also as a display device 10b (see FIG. 4) which is a display device such as a liquid crystal display device, an organic EL display device, etc. is provided in a front surface 2 of the information processing apparatus 1.

Virtual keys (software keys, SW keys) 11 are displayed on the touch screen 10. Characters or the like can be inputted or a key map can be changed by touching operation of the SW keys 11. In this embodiment, the SW keys 11 includes a key-mapping changeover key 12a disposed in the upper left of the touch screen 10, and a key-mapping changeover key 12b disposed in the upper right of the touch screen 10.

As shown in FIG. 2, mechanical keys (hardware keys, HW keys) 21 are arranged in a rear surface 3 of the information processing apparatus 1. In this embodiment, the HW keys 21 include plural keys. As shown in FIG. 3, the HW keys 21 are disposed in the left and right of the rear surface 3 so that a user can operate the HW keys 21 easily when the user holds the information processing apparatus 1. That is, the HW keys 21 are disposed in the left and right to which user's fingers can reach when the user operates the HW keys 21, that is, the HW keys 21 are not disposed in the center portion to which the user's fingers can hardly reach.

As shown in FIG. 3, the user holds the information processing apparatus 1 with right and left hands R and L. The user can perform touching operation on the touch screen 10 with thumbs of the right and left hands R and L while the user can perform key input operation of the HW keys 21 arranged in the rear surface 3 with other fingers (the index fingers, the middle fingers, the ring fingers and the little fingers) of the right and left hands R and L. The information processing apparatus 1 may be held by either of the right and left hands R and L.

For example, when the user touches the key-mapping changeover key 12a with the thumb of the left hand L, mapping of the HW keys 21 in FIG. 2 is changed.

The electrical configuration of the information processing apparatus 1 will be described here.

As shown in FIG. 4, the information processing apparatus 1 includes a key detector 31, a touch detector 32, a key input management module 33, plural HW key mapping tables 34a, 34b, . . . , SW key mapping tables 35, and a display controller 36, in addition to the touch screen 10 and the HW keys 21.

The key input management module 33 has a touch key determination module 37 which determines the kind of the SW key 11 which is touched on the touch screen 10, and a mapping change module 38 which changes the HW key mapping tables 34a, 34b, . . . to be used. Respective functional blocks of the key input management module 33 may be achieved by a program.

When one of the HW keys 21 in the rear surface 3 is pushed, the key detector 31 detects code information corresponding to the pushed HW key 21 and outputs the code information to the key input management module 33.

Each of the HW key mapping tables 34a, 34b, . . . as a memory stores code information and character information corresponding to the code information so that the code information and the character information are associated with each other. The HW key mapping tables 34a, 34b, . . . are tables different in kind for mapping different keys as the HW keys 21. The HW key mapping table is changed to one of the HW key mapping tables 34a, 34b, . . . by the mapping change module 38 when the key-mapping changeover key 12a or 12b as a changeover unit of the touch screen 10 is touched.

When code information is inputted from the key detector 31, the key input management module 33 reads out character information corresponding to the inputted code information by referring to any of the HW key mapping tables 34a, 34b, . . . changed by the mapping change module 38. The read-out character information is displayed on the touch screen 10 under control of the display controller 36.

When one of the SW keys 11 is pushed on the touch panel 10a of the touch screen 10, the touch detector 32 detects coordinate information and level information corresponding to the pushed SW key 11 and outputs the coordinate information and the level information to the key input management module 33.

Each of the SW key mapping tables 35 stores coordinate information on the touch screen 10 and character information corresponding to the coordinate information so that the coordinate information and the character information are associated with each other. Each of the SW key mapping tables 35 is related to displaying of SW keys 11 on the touch screen 10.

The touch key determination module 37 as a determination module determines whether the key-mapping changeover key 12a or 12b is touched or not, based on the coordinate information inputted from the touch detector 32, and outputs the determination result to the mapping change module 38.

The mapping change module 38 as a controller determines a HW key mapping table to be used, from the HW key mapping tables 34a, 34b, . . . in accordance with the result determined by the touch key determination module 37, and changes mapping of the HW keys 21 based on the determined HW key mapping table.

For example, when the key-mapping changeover key 12a or 12b on the touch screen 10 is touched in a state where the HW key mapping table 34a is used, the touch detector 32 detects coordinate information and outputs the coordinate information to the touch key determination module 37. When the key-mapping changeover key 12a or 12b is further touched, the HW key mapping table is changed to the next HW key mapping table. When the key-mapping changeover key 12a or 12b is then touched a predetermined number of times, the state is restored to a state where the HW key mapping table 34a is used. That is, whenever the key-mapping changeover key 12a or 12b is touched, the HW key mapping table to be used is changed in the sequence of 34a→34b→ . . . 34a→34b→ . . . . The sequence of change is not limited to the aforementioned sequence.

Operation of the information processing apparatus configured thus will be described below.

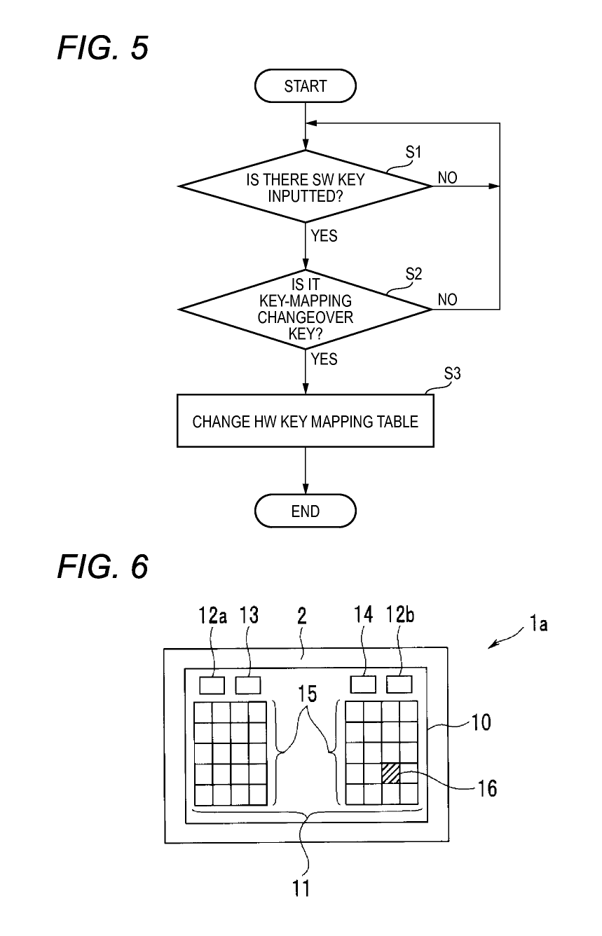

FIG. 5 is a flow chart for explaining a process of changing the HW key mapping table.

First, the touch detector 32 detects whether there is a SW key 11 inputted or not (step S1). When detection is made that there is no SW key 11 inputted, the processing goes back to the step S1 to repeat the same processing. On the other hand, when detection is made that there is a SW key 11 inputted, the touch key determination module 37 determines whether the inputted SW key 11 is either of the key-mapping changeover keys 12a and 12b or not (step S2). When the inputted SW key 11 is neither of the key-mapping changeover keys 12a and 12b, the processing goes back to the step S1 to repeat the same processing. On the other hand, when the inputted SW key 11 is either of the key-mapping changeover keys 12a and 12b, the mapping change module 38 changes the HW key mapping tables 34a, 34b, . . . to be used (step S3). Then, processing is terminated.

As described above, the information processing apparatus 1 is configured so that the key-mapping changeover keys 12a and 12b for changing mapping of the HW keys 21 are displayed on the touch screen 10, and that the HW key mapping tables 34a, 34b, . . . to be used are changed when either of the key-mapping changeover keys 12a and 12b is touched. As a result, a large number of keys can be mapped as the HW keys 21 provided in a limited region of the rear surface 3 of the information processing apparatus 1, so that various keys can be inputted.

### Modification

A modification of the first embodiment will be described below.

In the information processing apparatus 1 according to the first embodiment, the layout of the HW keys 21 is not general but the HW keys 21 are arranged in the rear surface 3. For this reason, the user can hardly recognize that which HW key 21 is in which position through a user's finger. An information processing apparatus 1a according to this modification facilitate inputting of HW keys 21.

FIG. 6 is a front view of the information processing apparatus according to the modification of the first embodiment.

As shown in FIG. 6, in the information processing apparatus 1a, a display changeover key (key position display changeover key) 13 is displayed adjacently to the key-mapping changeover key 12a while a mode changeover key (inputting mode/pre-typing mode changeover key) 14 is displayed adjacently to the key-mapping changeover key 12b.

When the user touches the display changeover key 13 as a changeover unit, position information 15 of the HW keys 21 disposed in the rear surface 3 is displayed on the touch screen 10. The position information 15 may be displayed only when the display changeover key 13 is being touched, or the display/non-display of the position information 15 may be switched whenever the display changeover key 13 is touched.

When the user touches the mode changeover key 14 as a changeover unit, an operating mode is switched from an inputting mode to a pre-typing mode (trial pushing mode) so that, upon user's pushing of any HW key 21 in the rear surface 3, position information 16 of the pushed HW key 21 is displayed on the touch screen 10. The operating mode is changed into the pre-typing mode only when the mode changeover key 14 is being touched, or the inputting mode/pre-typing mode may be switched whenever the mode changeover key 14 is touched. Pushing of the HW key 21 during the pre-typing mode is ignored.

The touch key determination module 37 determines touching of either of the display changeover key 13 and the mode changeover key 14, and the mapping change module 38 executes the aforementioned processing based on the determination result.

The display changeover key 13 and the mode changeover key 14 may be toggled between display and non-display (ON and OFF) whenever each of the display changeover key 13 and the mode changeover key 14 is touched, or the display changeover key 13 and the mode changeover key 14 may be displayed (ON) while each of the display changeover key 13 and the mode changeover key 14 is being touched. In this manner, the user can easily recognize that a user's finger is located at which place of which HW key 21.

Information of keys currently mapped in the HW keys 21 may be further displayed in the position information 15 of the HW keys 21. In this case, key input of the HW keys 21 may be further facilitated.

For example, each of keys forming the HW keys 21 arranged in the rear surface 3 may be provided with a touch sensor for detecting finger's touching a key, so that position information of the touched key can be displayed on the touch screen 10 based on the detection signal of the touch sensor. According to such a configuration, the finger's position can be displayed in real time on the touch screen 10 without operating the mode changeover key 14 and changing the operating mode into the pre-typing mode.

### Second Embodiment

A second embodiment will be described below.

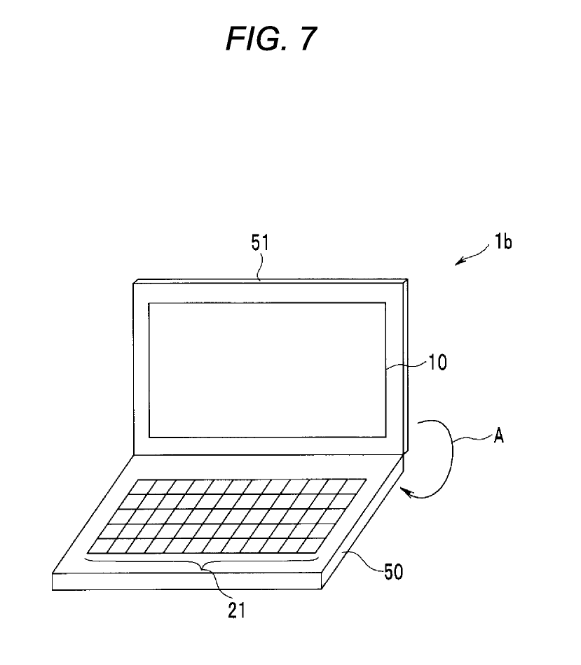

FIG. 7 is an external view of an information processing apparatus according to the second embodiment. In FIG. 7, the same constituent parts as those in FIGS. 1 and 2 are referred to by the same numerals and description thereof will be omitted.

As shown in FIG. 7, the information processing apparatus 1b is a foldable notebook type personal computer which includes a body unit 50 having HW keys 21 arranged therein, and a display unit 51 having a touch screen 10 disposed therein.

The information processing apparatus 1b can be used while held in hands. In this case, the information processing apparatus 1b can be folded in a direction of the arrow A (backward). That is, when a user folds the information processing apparatus 1b in the direction of the arrow A so that a rear surface of the display unit 51 comes into contact with a rear surface of the body unit 50, the user can perform operation using the touch screen 10 in the front surface and the HW keys 21 in the rear surface while holding the information processing apparatus 1b in the same manner as in the first embodiment.

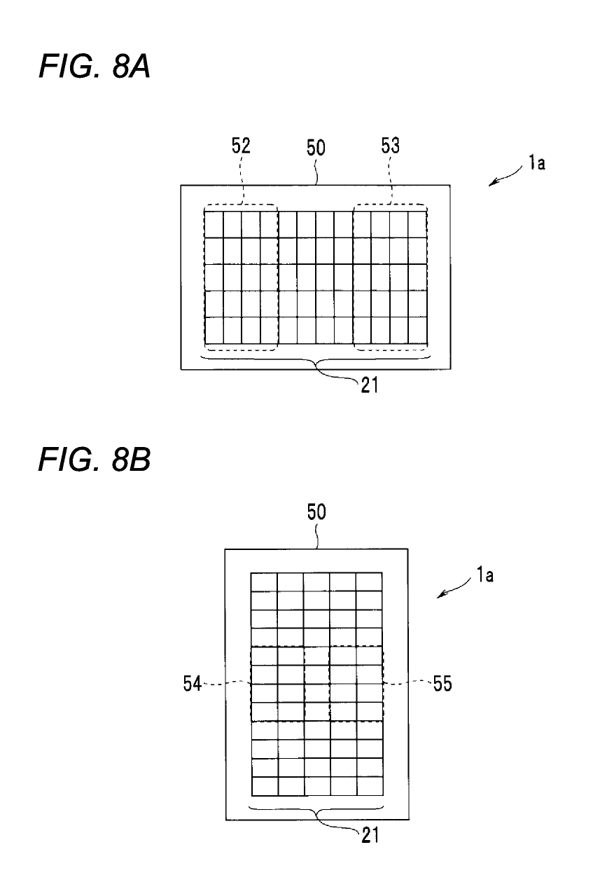

FIGS. 8A and 8B are rear views of the information processing apparatus 1b folded in the direction of the arrow A.

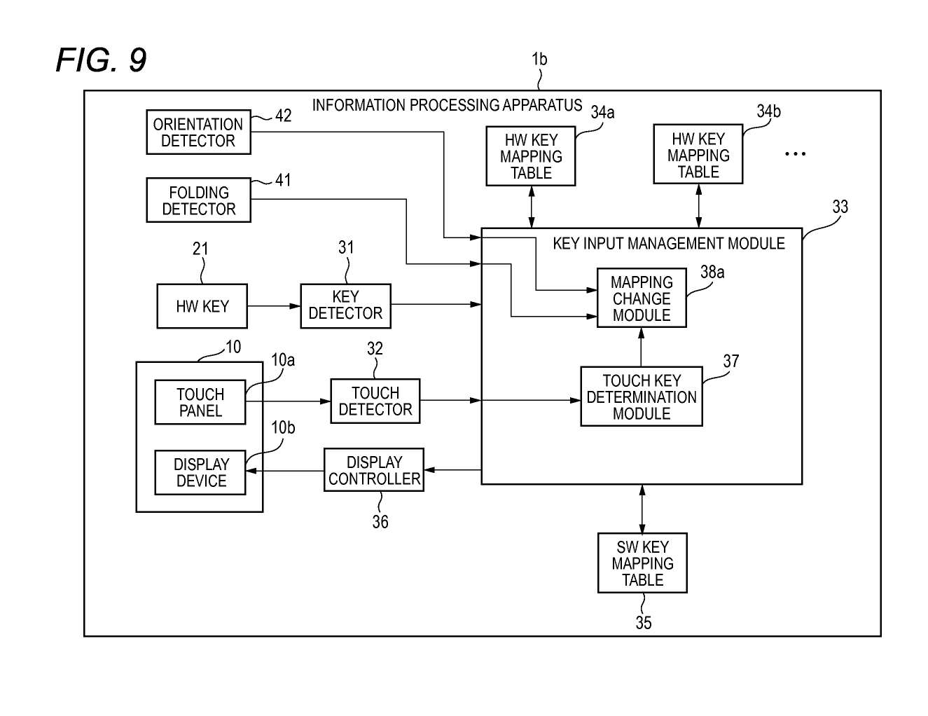

When the information processing apparatus 1b is folded in the direction of the arrow A, the HW key mapping tables 34a, 34b, . . . are changed so that only keys arranged in regions 52 and 53, out of the HW keys 21 in the rear surface are validated as shown in FIG. 8A. For example, when the information processing apparatus 1b is rotated by 90 degrees in the state where the information processing apparatus 1b is folded in this manner, the HW key mapping tables 34a, 34b, . . . are changed so that only keys arranged in regions 54 and 55, out of the HW keys 21 in the rear surface are validated as shown in FIG. 8B. Keys mapped in invalidated regions in FIGS. 8A and 8B are remapped in the validated regions 52 to 55 by the key-mapping changeover key 12a or 12b displayed on the touch screen 10 in the same manner as in the first embodiment. Such a process of changing the HW key mapping tables 34a, 34b, . . . will be described in detail with reference to FIG. 9.

FIG. 9 illustrates an electrical configuration of the information processing apparatus according to the second embodiment. In FIG. 9, the same constituent parts as those in FIG. 4 are referred to by the same numerals and description thereof will be omitted.

As shown in FIG. 9, the information processing apparatus 1b includes a mapping change module 38a used in place of the mapping change module 38 of the information processing apparatus 1 according to the first embodiment, and a folding detector 41 and an orientation detector 42 which are provided additionally.

The folding detector 41 detects whether the information processing apparatus 1b is folded in the direction of the arrow A or not, and outputs the detection result to the mapping change module 38a. Although the folding detector 41 is a contact switch provided in a position where the body unit 50 and the display unit 51 face each other, the folding detector 41 is not limited thereto. For example, the folding detector 41 may be a magnetic switch or the like.

For example, the orientation detector 42 is a gravity sensor. The orientation detector 42 detects the orientation of the information processing apparatus 1b, that is, whether the information processing apparatus 1b is used in a state shown in FIG. 8A or whether the information processing apparatus 1b is used in a state shown in FIG. 8B, and outputs the detection result to the mapping change module 38a.

The mapping change module 38a changes the HW key mapping tables 34a, 34b, . . . based on the result detected by the folding detector 41 and the result detected by the orientation detector 42.

When the folding detector 41 detects folding of the information processing apparatus 1b and the orientation detector 42 detects that the information processing apparatus 1b is oriented to a direction shown in FIG. 8A (the touch screen 10 is used so as to be long sideways), the mapping change module 38a changes the HW key mapping table to a folding HW key mapping table and validates keys of the HW keys 21 in the regions 52 and 53.

On the other hand, when the folding detector 41 detects folding of the information processing apparatus 1b and the orientation detector 42 detects that the information processing apparatus 1b is oriented to a direction shown in FIG. 8B (the touch screen 10 is used so as to be long lengthways), the mapping change module 38a changes the HW key mapping table in accordance with the orientation and validates keys of the HW keys 21 in the regions 54 and 55.

Operation of the information processing apparatus 1b configured thus will be described below.

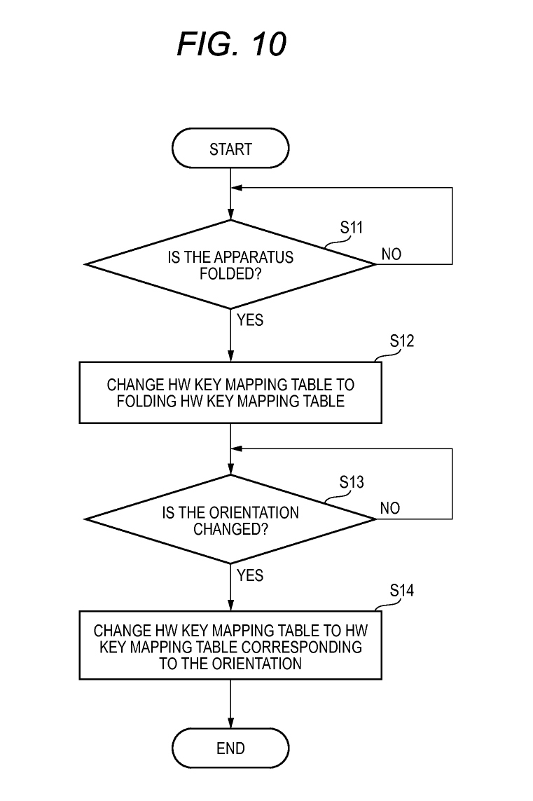

FIG. 10 is a flow chart for explaining a process of changing the HW key mapping table.

First, the folding detector 41 detects whether the information processing apparatus 1b is folded in the direction of the arrow A or not (step S11). When the information processing apparatus 1b is not folded in the direction of the arrow A, the processing goes back to the step S11 to repeat the same processing. On the other hand, when the information processing apparatus 1b is folded in the direction of the arrow A, the mapping change module 38a changes the HW key mapping table to be used, to a folding HW key mapping table (step S12).

Then, the orientation detector 42 detects whether the orientation of the information processing apparatus 1b is changed or not (step S13). When the orientation of the information processing apparatus 1b is not changed, the processing goes back to the step S13 to repeat the same processing. On the other hand, when the orientation of the information processing apparatus 1b is changed, the mapping change module 38a changes the HW key mapping table to be used, to a HW key mapping table corresponding to the orientation (step S14). Then, processing is terminated. When the key-mapping changeover key 12a or 12b displayed on the touch screen 10 is touched while the process of changing the HW key mapping table shown in FIG. 10 is in execution, the process of changing the HW key mapping table shown in FIG. 6 is executed.

As described above, the information processing apparatus 1b is configured so that backward folding and orientation are detected and the HW key mapping tables 34a, 34b, . . . are changed in accordance with the detection result so that only HW keys 21 in a range to which user's fingers can reach are validated. As a result, key input operation in the information processing apparatus 1b can be performed easily because it is unnecessary to input HW keys 21 in the center portion to which the user's fingers can hardly reach.

All or part of a program executing the aforementioned operation is recorded or stored as a computer program product in a portable medium such as a flexible disk, a CD-ROM, etc., or a storage device such as a hard disk, etc. The program is read by the computer and all or part of operation is executed. Alternatively, all or part of the program can be distributed or provided through a communication network. The user can install the program in the computer by downloading the program through the communication network or can install the program in the computer from a recording medium, so that the information processing apparatus or the control method according to each of the aforementioned embodiments can be achieved easily.

Respective steps in each of the above-exemplified flow charts may be executed in a changed sequence or partly simultaneously, according to each execution, as long as there is no contradiction to the properties of the steps.

Although some embodiments have been described, these embodiments are presented by way of example but not intended to limit the scope of the invention. These novel embodiments can be carried out in other various modes and various omissions, replacements and changes may be made without departing from the spirit of the invention. These embodiments and their modifications will also fall within the scope of Claims and its equivalents.

1. An information processing apparatus comprising:
a display device;
a touch panel provided on a front surface of the display device, the touch panel including a first changeover unit;
mechanical keys arranged in a rear surface of the display device;
a memory which stores plural designation information each corresponding to a designation of functions to the mechanical keys;
a determination module which determines whether the first changeover unit is selected through the touch panel or not; and
a controller which determines one of the plural designation information in accordance with a determination result by the determination module and changes the designation of functions to the mechanical keys based on the determined designation information.

2. The information processing apparatus of claim 1,
wherein the touch panel further includes a second changeover unit,
wherein the determination module determines whether the second changeover unit is selected through the touch panel or not, and
wherein the controller controls the display device to display a positional arrangement of the mechanical keys when the determination module determines that the second changeover unit is selected through the touch panel.

3. The information processing apparatus of claim 1,
wherein the touch panel further includes a third changeover unit,
wherein the determination module determines whether the third changeover unit is selected through the touch panel or not, and
wherein the controller controls the display device to indicate, upon operation onto one of the mechanical keys, the operated mechanical key when the determination module determines that the third changeover unit is selected through the touch panel.

4. An information processing apparatus comprising:
a body unit having mechanical keys on a front surface thereof;
a display unit having a display device on a front surface thereof, a touch panel being provided on the display device;
a memory which stores plural designation information each corresponding to a designation of functions to the mechanical keys;
a detector which detects whether or not the information processing apparatus is folded so that a rear surface of the body unit comes into contact with a rear surface of the display unit; and
a controller which determines one of the designation information in accordance with a detection result by the detector and changes the designation of functions to the mechanical keys based on the determined designation information.

5. A method of controlling an information processing apparatus, comprising:
determining whether or not a first changeover unit displayed on a touch panel provided on a front surface of a display device is selected; and
determining one of plural designation information each corresponding to a designation of functions to mechanical keys arranged in a rear surface of the display device in accordance with the determination result; and
changing the designation of functions to the mechanical keys based on the determined designation information.

6. The method of claim 5, comprising:
determining whether a second changeover unit further displayed on the touch panel of the display device is selected or not; and
controlling the display device to display a positional arrangement of the mechanical keys when the determination module determines that the second changeover unit is selected.

7. The method of claim 5, comprising:
determining whether a third changeover unit further displayed on the touch panel of the display device is selected or not; and
controlling the display device to indicate, upon operation onto one of the mechanical keys, the operated mechanical key when the determination module determines that the third changeover unit is selected.

8. A method of controlling an information processing apparatus, comprising:
detecting whether or not the information processing apparatus is folded such that a rear surface of a body unit, which is opposite to a front surface having mechanical keys, comes into contact with a rear surface of a display unit, which is opposite to a front surface having a touch panel; and
determining one of plural designation information each corresponding to a designation of functions to the mechanical keys in accordance with the detection result; and
changing the designation of functions to the mechanical keys based on the determined designation information.

9. A program for enabling an information processing apparatus to execute:
determining whether or not a first changeover unit displayed on a touch panel provided on a front surface of a display device is selected; and
determining one of plural designation information each corresponding to a designation of functions to mechanical keys arranged in a rear surface of the display device in accordance with the determination result; and
changing the designation of functions to the mechanical keys based on the determined designation information.

10. The program of claim 9, further enabling:
determining whether a second changeover unit further displayed on the touch panel of the display device is selected or not; and
controlling the display device to display a positional arrangement of the mechanical keys when the determination module determines that the second changeover unit is selected.

11. The program of claim 9, further enabling:
determining whether a third changeover unit further displayed on the touch panel of the display device is selected or not; and
controlling the display device to indicate, upon operation onto one of the mechanical keys, the operated mechanical key when the determination module determines that the third changeover unit is selected.

12. A program for enabling an information processing apparatus to execute:
detecting whether or not the information processing apparatus is folded such that a rear surface of a body unit, which is opposite to a front surface having mechanical keys, comes into contact with a rear surface of a display unit, which is opposite to a front surface having a touch panel; and
determining one of plural designation information each corresponding to a designation of functions to the mechanical keys in accordance with the detection result; and
changing the designation of functions to the mechanical keys based on the determined designation information.
